(19) United States
(12) Patent Application Publication
(10) Pub. No.: US 2019/0265686 A1
(43) Pub. Date: Aug. 29, 2019

(54) PRODUCT QUALITY MANAGEMENT SYSTEM AND METHOD FOR MANAGING QUALITY OF PRODUCT

(71) Applicant: Kabushiki Kaisha Yaskawa Denki, Kitakyushu-shi (JP)

(72) Inventors: Shinichiro OBATA, Kitakyushu-shi (JP); Hidemitsu JIN, Kitakyushu-shi (JP); Tadashi OKUBO, Kitakyushu-shi (JP); Takeshi NAGATA, Kitakyushu-shi (JP)

(73) Assignee: Kabushiki Kaisha Yaskawa Denki, Kitakyushu-shi (JP)

(21) Appl. No.: 16/151,521

(22) Filed: Oct. 4, 2018

(30) Foreign Application Priority Data
Feb. 23, 2018 (JP) 2018-031308

(51) Int. Cl. G05B 19/418; G06T 7/00

(52) U.S. Cl. CPC G05B 19/41875; G05B 2219/32222; G05B 2219/32191; G06T 7/0004

(57) ABSTRACT

A product quality management system includes a production facility that produces a product having a target resulting parameter, estimation circuitry that estimates an active parameter for controlling the production facility in producing the product under a predetermined passive parameter condition, and control circuitry that controls the production facility based on the active parameter estimated by the estimation circuitry.

### CROSS-REFERENCE TO RELATED APPLICATIONS

The present application claims priority under 35 U.S.C. § 119 to Japanese Patent Application No. 2018-031308, filed Feb. 23, 2018. The contents of this application are incorporated herein by reference in their entirety.

### BACKGROUND

### Field of the Invention

The embodiments disclosed herein relate to a product quality management system and a method for managing quality of a product.

### Discussion of the Background

JP 6233061B discloses determining whether there is a defect-causing abnormality in a production facility when a defect has been identified in a product. Specifically, JP 6233061B discloses making this determination by comparing an observation value obtained by processing the defective product with an observation value obtained by processing a defective-free product.

### SUMMARY

According to one aspect of the present invention, a product quality management system includes a production facility that produces a product having a target resulting parameter, estimation circuitry that estimates an active parameter for controlling the production facility in producing the product under a predetermined passive parameter condition, and control circuitry that controls the production facility based on the active parameter estimated by the estimation circuitry.

According to another aspect of the present invention, a method for managing quality of a product using a production facility includes estimating an active parameter for controlling a production facility that produces a product having a target resulting parameter in producing the product under a predetermined passive parameter condition, and controlling the production facility based on the active parameter estimated.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram illustrating a configuration of a product quality management system;

FIG. 2 is a block diagram illustrating a configuration of an image data recorder;

FIG. 3 illustrates kinds of parameters used in production of a product in a typical production facility and illustrates how the parameters relate to each other;

FIG. 4 is an example neural network model of deep learning used in a control parameter estimator;

FIG. 5 illustrates an example estimator-learning data set that the control parameter estimator learns;

FIG. 6 illustrates an example of standard image data and an example of lot image data superimposed on each other;

FIG. 7 illustrates an example difference image data;

FIG. 8 illustrates example combinations of standard image data and lot image data that are used to extract difference image data;

FIG. 9 illustrates an example model of the control parameter estimator outputting an upper limit value and a lower limit value of a control parameter command;

FIG. 10 illustrates an example model of the control parameter estimator outputting an optimal control parameter command;

FIG. 11 illustrates an example model of the control parameter estimator implementing mass-production of the same products;

FIG. 12 illustrates an example model of the control parameter estimator implementing production of a wide variety of products;

FIG. 13 illustrates an example model of the control parameter estimator implementing production of a wide variety of products with a manipulable environment parameter;

FIG. 14 illustrates an example combination of lot image data between which difference image data are extracted;

FIG. 15 illustrates an example model of the control parameter estimator implementing a feedback loop of product parameter data based on a mathematical model; and

FIG. 16 illustrates an example model of the control parameter estimator implementing a feedback loop vision data based on deep learning.

### DESCRIPTION OF THE EMBODIMENTS

The embodiments will now be described with reference to the accompanying drawings, wherein like reference numerals designate corresponding or identical elements throughout the various drawings.

### 1: General Arrangement of Product Quality Management System

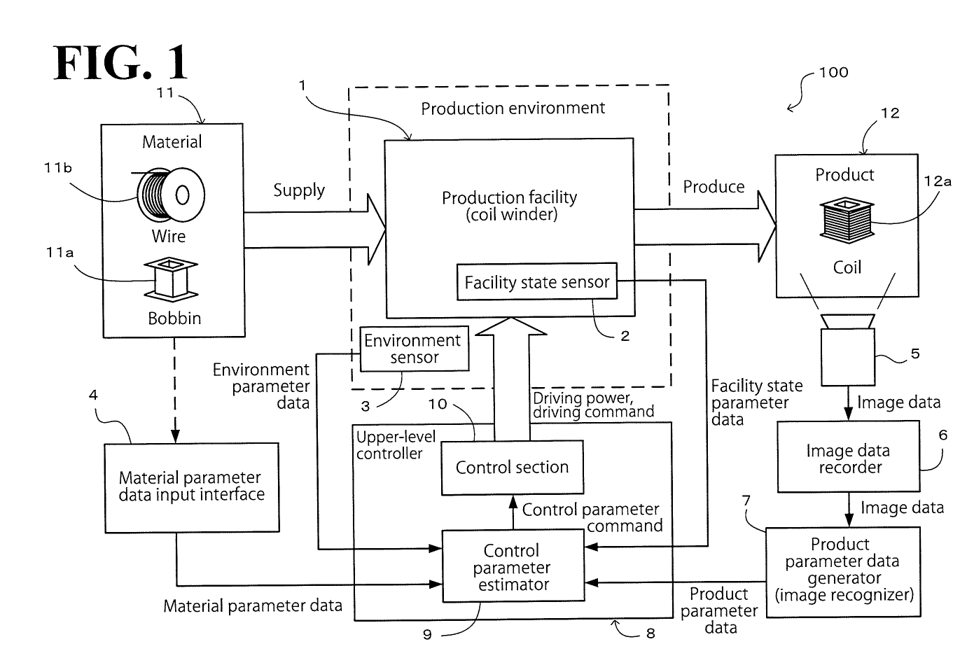

By referring to FIG. 1, a general arrangement of a product quality management system 100 according to this embodiment will be described.

FIG. 1 is a block diagram illustrating a configuration of the product quality management system 100. In this embodiment, the product quality management system 100 is applied to a production facility that produces a coil by winding a wire around a bobbin. As illustrated in FIG. 1, the product quality management system 100 includes a production facility 1, a facility state sensor 2, an environment sensor 3, a material parameter data input interface 4, a camera 5, an image data recorder 6, a product parameter data generator 7, and a controller 8.

The production facility 1 is a machine driven by a predetermined motive power source, not illustrated, to perform predetermined processing of a material 11 when the material 11 is supplied to the production facility 1. By processing the material 11, the production facility 1 produces the product 12, which has a predetermined specification(s) and a predetermined quality. In this embodiment, the production facility 1 is a coil winder. Specifically, the material 11 includes a bobbin 11a and a wire 11b. When the bobbin 11a and the wire 11b are supplied to the production facility 1, the production facility 1 winds the wire 11b around the bobbin 11a, thereby producing a coil 12a, which is the product 12.

The facility state sensor 2 (passive data obtainer) is located in the production facility 1 and is a sensor that detects a state(s) of the production facility 1 that can affect specifications and quality of the product 12 (coil 12a). A non-limiting example of the facility state sensor 2 is an optical sensor that detects the degree of wear and tear of a portion of the production facility 1 that contacts an object such as a material 11 while the production facility 1 is in operation.

The environment sensor 3 (passive data obtainer) is located in or near the production facility 1 and is a sensor that detects an environment state in or near the production facility 1 that can affect specifications and quality of the product 12 (coil 12a). A non-limiting example of the environment sensor 3 is a sensor that detects temperature, humidity, vibration, and/or other ambient conditions around a portion of the production facility 1 that directly processes a material 11 while the production facility 1 is in operation. It will be understood by those skilled in the art that the environment sensor 3 (passive data obtainer) may be located in or around the controller 8 and detect a state equivalent to an environment state in or near the production facility 1.

The material parameter data input interface 4 (passive data obtainer) receives information of specification(s) and quality of the material 11 supplied to the production facility 1 (this information will be hereinafter referred to as material parameter data). In this embodiment, bobbins 11a and wires 11b are industrial products each produced using approximately coherent designed values, and thus it is possible to assume that there is approximately no difference in specification(s) and quality between bobbins 11a and between wires 11b. In this case, specification values (designed values) of the material 11 (the bobbin 11a and the wire 11b) that can affect specifications and quality of the product 12 (coil 12a) are used as material parameter data and manually input into the material parameter data input interface 4. In the material parameter data input interface 4, the material parameter data is registered as common material parameter data. In the following description, an information item will be referred to as “parameter”, and a collection of actually input values and a collection of observation values obtained through observations will be referred to as “parameter data”.

The camera 5 (resulting data obtainer) is an optical sensor that optically picks up an image of an exterior of an imaging target to obtain image data of the imaging target in the form of two-dimensional pixel array data. In this embodiment, the imaging target is the product 12 (coil 12a), which is produced by the production facility 1, and the camera 5 picks up an image of an exterior of each individual coil 12a. Then, the camera 5 outputs the obtained image data to the image data recorder 6, described later.

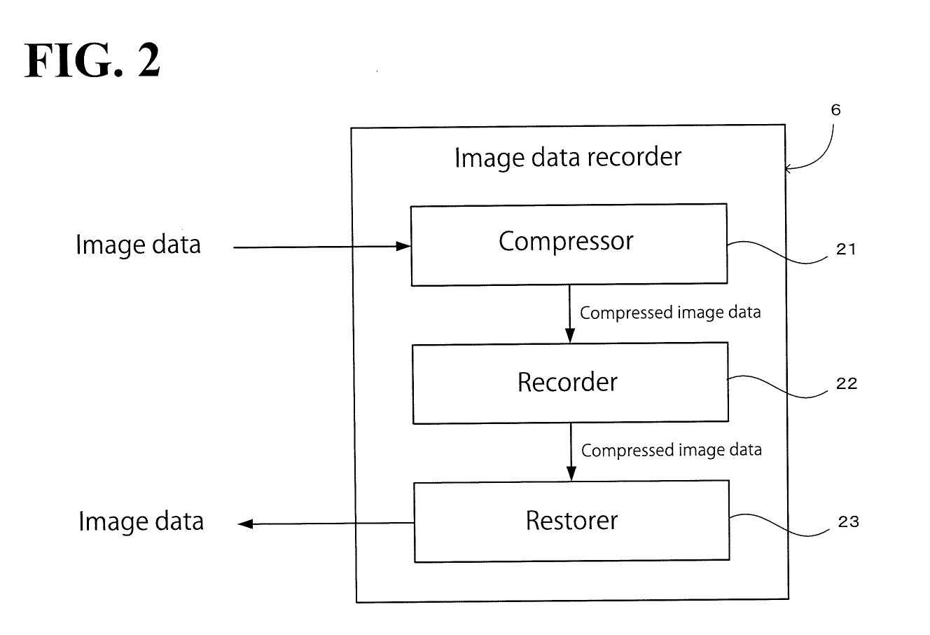

The image data recorder 6 is a server that records the image data of the product 12 obtained by the camera 5. Specifically, the image data recorder 6 compresses the input image data to decrease the capacity of the image data, and stores the decreased capacity of the image data (see FIG. 2, described later).

The product parameter data generator 7 (resulting data obtainer) is an image recognizer that performs image recognition of the image data obtained from the image data recorder 6 to obtain predetermined information of specification(s) and quality from the exterior of the product 12 (coil 12a) imaged in the image data. Then, the product parameter data generator 7 outputs the obtained information as product parameter data. It will be understood by those skilled in the art that the image recognition processing performed by the product parameter data generator 7 may be implemented by machine learning such as deep learning (convolutional neural network), or may be implemented by a method that is not based on machine learning, examples including raster scanning and correlation detection.

The controller 8 controls a motion of the production facility 1, and includes a control parameter estimator 9 and a control section 10.

The control parameter estimator 9 receives the facility state parameter data, the environment parameter data, the material parameter data, and the product parameter data from the above-described elements. Based on these pieces of data, the control parameter estimator 9 estimates a content of a control parameter command necessary for controlling the production facility 1 to produce a product 12 (coil 12a) having a target specification(s) and a target quality. As used herein, the “control parameter command” refers to a collection of command values of “control parameters”. The command values are generated by the control parameter estimator 9. The control parameters are items of the control information of control of the production facility 1. The control parameter estimator 9 is a non-limiting example of the estimator recited in the appended claims.

Based on the control parameter command output from the control parameter estimator 9, the control section 10 outputs driving electric power and driving command for controlling a motion of the production facility 1.

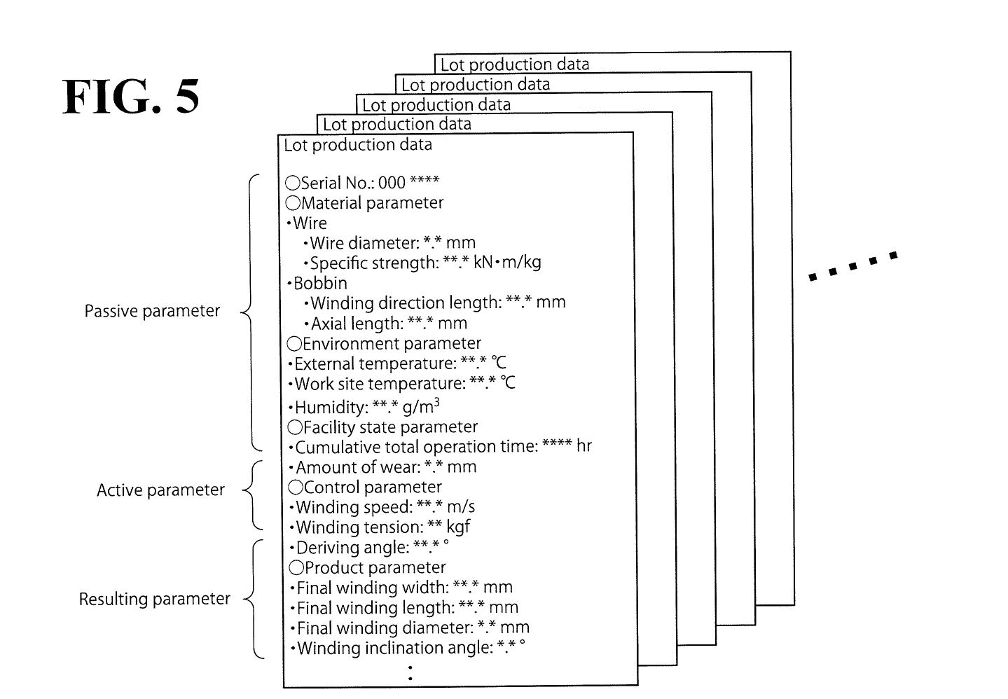

The control parameters will be detailed later by referring to FIG. 5.

### 2: Configuration of Image Data Recorder

FIG. 2 is a block diagram illustrating a configuration of the image data recorder 6. Referring to FIG. 2, the image data recorder 6 includes a compressor 21, a recorder 22, and a restorer 23.

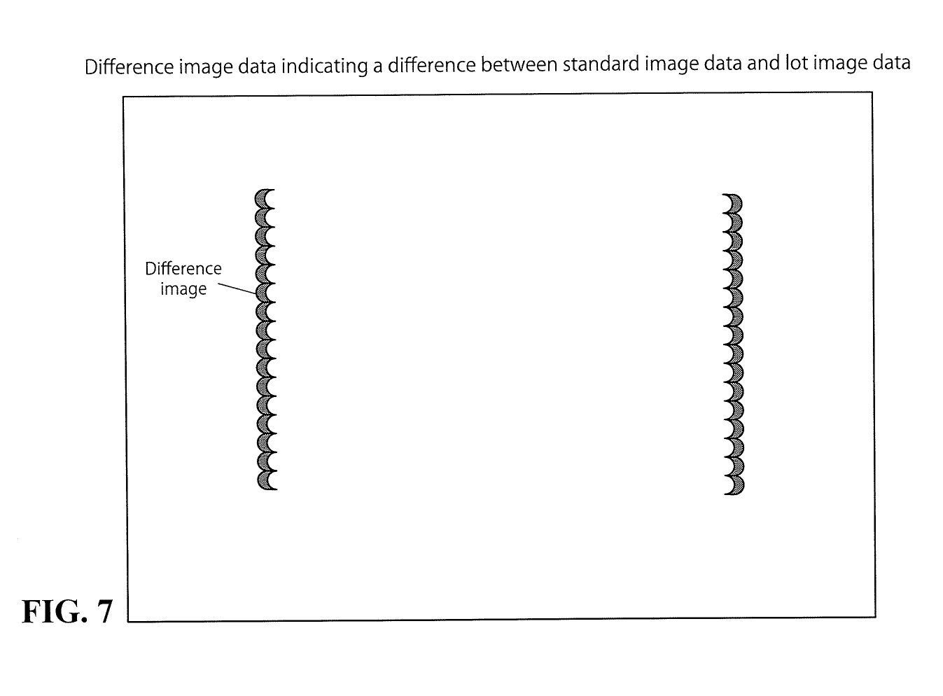

The compressor 21 receives image data of a product 12 from the camera 5 and performs predetermined compression processing of the image data to generate compressed image data of decreased data capacity. This compression processing will be described in detail later by referring to FIGS. 7 to 9.

The recorder 22 records and manages the compressed image data generated at the compressor 21. The recorder 22 performs the recording and management on an individual-lot basis (on an individual-product 12 basis).

The restorer 23 performs restoration processing of the compressed image data obtained from the recorder 22 to obtain the original image data. The restoration processing is the inverse of the compression processing at the compressor 21.

Thus, even though large volumes of image data, which has a large capacity, are generated on an individual-lot basis (on an individual-product 12 basis), each volume of image data is compressed to a smaller capacity, enabling the image data to be more efficiently stored in the recorder 22. It will be understood by those skilled in the art that the compressor 21 may be provided in the camera 5, or the restorer 23 may be provided in the controller 8. In these cases, even though large volumes of image data are sent and received through the communication network between the camera 5, the image data recorder 6, and the controller 8, the smallness of each volume of data capacity saves the load on the communication network.

3: Features of this Embodiment

As seen from the above description, an industrial production form currently in wide use is that a machine (production facility 1) driven by a predetermined motive power source is supplied the material 11 and performs predetermined processing of the material 11 to automatically produce a product 12 having target specifications. Specifically, examples of the processing performed by the production facility 1 include: mechanical processing (such as chipping, cutting, bending, extension, compression, heating, cooling, and welding) to produce and/or assemble parts; processing utilizing physical, electromagnetic, and/or chemical properties of the material 11, and/or utilizing physical, electromagnetic, and/or chemical reactions of the material 11; and processing performed when the material 11 is a plant, such as aiding the growth of plants. Through these processings, products 12 (such as mechanical machines, electrical machines, food products, plants, and medical/chemical substances) are produced. The production facility 1 is capable of processing materials 11 continuously supplied to the production facility 1 and mass-producing products 12 having approximately the same specification(s) and quality. As necessary, the production facility 1 is also capable of producing a wide variety of products 12 having different specifications by changing settings of the processing of materials 11.

It should be noted, however, that specification(s) and quality greatly vary from product 12 and product 12 depending on which materials 11 are supplied, under which environment materials 11 are processed, and which processing is performed. Among these product 12-affecting factors, “which processing is performed” is the only factor that is manipulable at the production facility 1, while the other factors cannot be manipulated at the production facility 1. Still, there is a need for stably producing products 12 having a desired specification(s) and a desired quality even though it is inevitable that the other factors are subject to change.

In light of the circumstances, the product quality management system 100 according to this embodiment includes the control parameter estimator 9 and the control section 10. The control parameter estimator 9 estimates an active parameter necessary for controlling the production facility 1 to produce a product 12 having a target resulting parameter (that is, a target specification(s) and a target quality) when the production facility 1 is given a particular passive parameter. The control section 10 controls the production facility 1 based on the active parameter estimated by the control parameter estimator 9.

As used herein, the passive parameter is a collective term of quantified information of passively given factors that cannot be manipulated at the production facility 1. Also as used herein, the active parameter is a collective term of quantified information of factors manipulable at the controller 8. Also as used herein, the resulting parameter is a collective term of quantified information of specifications of the product 12 produced based on these parameters. With these terms thus defined, the production facility 1 can be described as being controlled based on the active parameter, when the production facility 1 is given a passive parameter, to produce the product 12 having the resulting parameter. Each of the passive parameter and the active parameter is preferably made up of only those factors that can affect the resulting parameter.

The control parameter estimator 9 estimates an active parameter necessary for controlling the production facility 1 to produce a product 12 having a target content as the resulting parameter when the production facility 1 is given a passive parameter. The control section 10 controls the production facility 1 based on the estimated active parameter. This enables the production facility 1 to stably produce products 12 each having a target resulting parameter even though it is inevitable that the passive parameter, which cannot be manipulated at the production facility 1, is subject to change. How to implement this function will be described in detail below.

### 4: Relationship Between Parameters and Design of Control Parameter Estimator

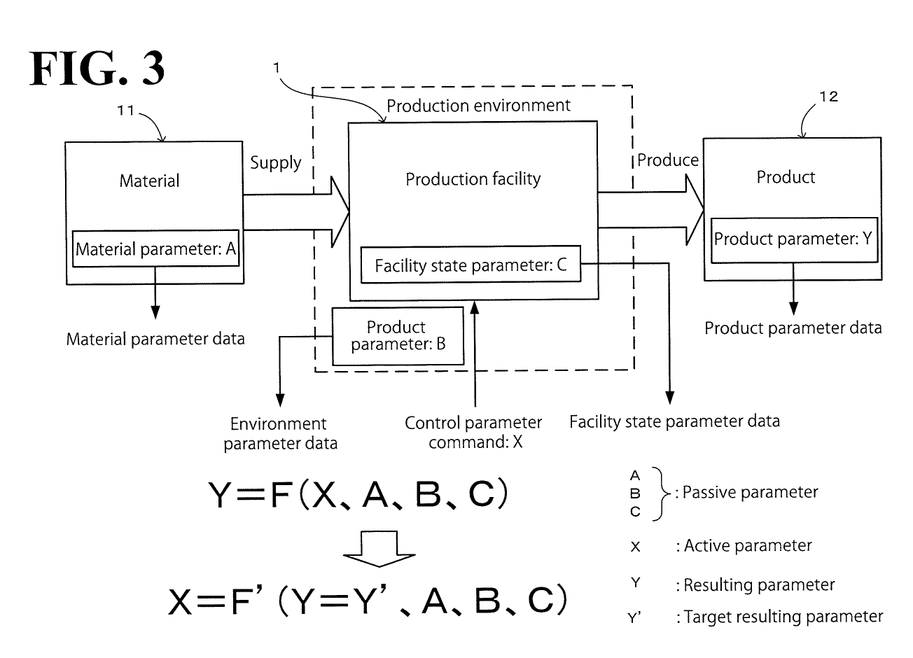

FIG. 3 illustrates kinds of parameters used in production of a product 12 in a typical production facility 1 and illustrates how the parameters relate to each other. As described above, the production facility 1 is supplied the material 11 and performs predetermined processing of the material 11 to automatically produce a product 12 having predetermined specifications.

Referring to FIG. 3, material parameter A is an item that indicates information of specification(s) and quality of the material 11, and material parameter data (passive data) is a collection of actual values (or specification values) of the specification(s) and quality of the material 11.

Also referring to FIG. 3, environment parameter B is an item that indicates information of the production environment in or around the production facility 1 producing the product 12, and environment parameter data (passive data) is a collection of actual observation values of the production environment.

Also referring to FIG. 3, facility state parameter C is an item that indicates information of a state of the production facility 1 that can affect specifications and quality of the product 12 produced by the production facility 1, and facility state parameter data (passive data) is a collection of actual observation values of the state of the production facility 1.

Also referring to FIG. 3, control parameter X (facility control parameter) is an item that indicates information necessary for controlling the production facility 1 to produce the product 12, and control parameter command X (active data) is a collection of command values of the control parameter that are input into the control section 10 (not illustrated in FIG. 3) to control the production facility 1.

Also referring to FIG. 3, product parameter Y is an item that indicates information of specification(s) and quality of the product 12 produced by the production facility 1, and product parameter data Y (resulting data) is a collection of actual values of the specification(s) and quality of the product 12.

Among these parameters, the material parameter A, the environment parameter B, and the facility state parameter C can be regarded and classified as passive parameters, which are passively given to the production facility 1 and cannot be manipulated at the production facility 1. The control parameter X can be regarded and classified as an active parameter, which is manipulable at the controller 8. The product parameter Ycan be regarded and classified as a resulting parameter, which indicates a state associated with a specification(s) of the product 12 produced based on these parameters.

It will be understood by those skilled in the art that either one item or a plurality of items may be set in each of the above-described parameters. Specifically, an item or items of the resulting parameter may be freely set by a user, while the passive parameter and the active parameter preferably have a necessary and sufficient number of items that can affect (that are correlated to) the resulting parameter. The above-described parameter data and control parameter command are obtained and managed on an individual-product (lot, serial) basis.

The above-described parameters associated with product production have a relationship represented by Y=F(X, A, B, C). In this relational expression, the function F is a multivariable function specified by the configuration and processing of the production facility 1. Specifically, the production facility (F) can be described as being controlled based on the active parameter X to produce a product 12 having the resulting parameter Y under the A, B, C passive parameter conditions.

The control parameter estimator 9 estimates an active parameter X necessary for controlling the production facility 1 to make the resulting parameter Y of the product 12 a target resulting parameter (=target resulting parameter data Y′) under the A, B, C passive parameter conditions. For this purpose, the control parameter estimator 9 designs a multivariable function of F′ to secure the relationship X=F′ (Y=Y′, A, B, C). That is, while ensuring that the passive parameters A, B, and C, the active parameter X, and the resulting parameter Y remain correlated to each other as in the original multivariable function F, the control parameter estimator 9 designs an inverse multivariable function F′ such that: the resulting parameter Y fixed to the target resulting parameter data Y′ is set as an explanatory variable; the passive parameters A, B, and C is set as an explanatory variable; and with the active parameter X is set as an objective variable.

### 5: Specific Example of how Control Parameter Estimator is Implemented

The control parameter estimator 9 may be implemented in any of various forms. For example, it is possible to use a mathematical model with contents of the parameters and how the contents of the parameters are correlated to each other taken into consideration. For further example, it is possible to use a statistical operation (calculation). In this embodiment, the control parameter estimator 9 is implemented using machine learning, which will be described below. While there are various forms of machine learning itself, the following description will be concerning deep learning used as machine learning algorithm.

### 5-1: Control Parameter Estimator Implemented by Deep Learning

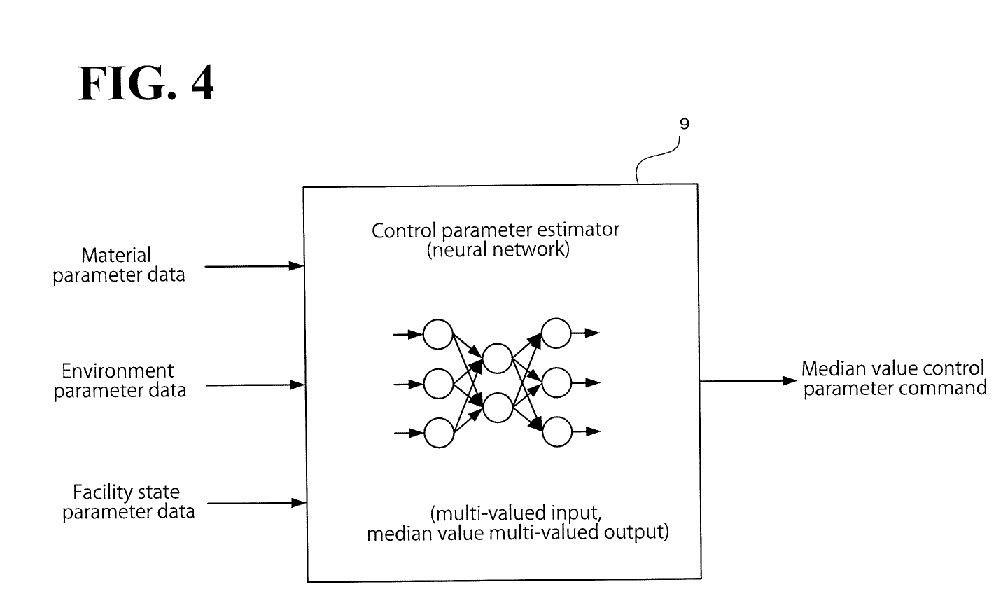

FIG. 4 is an example neural network model of deep learning used in the control parameter estimator 9. As illustrated in FIG. 4, the neural network of the control parameter estimator 9 receives a large number of material parameter data, environment parameter data, and facility state parameter data from the various sensors and the material parameter data input interface 4. Then, the neural network of the control parameter estimator 9 outputs a control parameter command so that at the time when each parameter data is obtained, the resulting parameter has target contents set in advance (that is, so that the product 12 has target specifications and a target quality).

In the example illustrated in FIG. 4, multi-valued parameter data are input into the input node, and a median value (described later) of a control parameter command range that makes the resulting parameter have target contents is output on multi-levels. This estimation processing is based on what is learned in the machine learning process of the learning phase of the control parameter estimator 9. That is, the neural network of the control parameter estimator 9 learns a feature quantity indicating a correlation (correspondence) between each input parameter data and the output median-value control parameter command.

The machine learning process of the control parameter estimator 9 is implemented such that the above designed multi-layer neural network is implemented on the controller 8 in the form of software (or hardware), and then the control parameter estimator 9 learns by “supervised learning” using a large number of estimator-learning data sets stored in an internal database (not illustrated) of the controller 8. Examples of the estimator-learning data sets are illustrated in FIG. 5. As illustrated in FIG. 5, each one estimator-learning data set corresponds to a different individual product 12 (lot, serial), and lists contents of the parameter data such that observation values and input values of the parameter data and contents of the control parameter command are correlated to each other. A large number of such estimator-learning data sets are prepared by producing a wide variety of products 12 based on a wide variety of materials, environments, facility states, and commands and by obtaining, from the products 12, combinations of a wide variety of parameter data and control parameter commands. The prepared estimator-learning data sets are stored in the internal database (not illustrated) of the controller 8. The function of the controller 8 to obtain the control parameter command (active data) in preparing an estimator-learning data set is a non-limiting example of the active data obtainer recited in the appended claims.

In this embodiment, in the learning phase of the control parameter estimator 9, only those estimator-learning data sets, among the large number of estimator-learning data sets, that have target resulting parameter contents (that is, an estimator-learning data set corresponding to a defective-free product) are employed as training data. Using the training data, the control parameter estimator 9 learns by, for example, “back propagation processing (error back propagation)”. Specifically, the weight coefficients of the edges connecting the nodes of the input layer and the output layer of the neural network of the control parameter estimator 9 are adjusted to establish a relationship between the input layer and the output layer. In order to improve processing accuracy, it is possible to employ, instead of or in addition to back propagation, other various learning methods such as stacked auto encoder, restricted Boltzmann machine, dropout, noise addition, and sparse regularization.

In this deep learning, a multiple regression analysis is performed with the resulting parameter Y fixed to the target resulting parameter data Y′, with the passive parameters A, B, and C used as explanatory variables, and with the active parameter X used as objective variable. As a result, the control parameter estimator 9 is implemented as multivariable function F′, satisfying the above-described relationship X=F′ (Y=Y′, A, B, C).

In the example estimator-learning data set illustrated in FIG. 5, the kinds of parameter data are set by: setting the resulting parameter data (such as winding width and winding length) based on externally recognizable mechanical properties (recognizable from image data picked up by the camera 5) of the coil 12a, which is the product 12; and by setting the other parameter data as parameter data that can affect the resulting parameter data. This manner of setting, however, is not intended in a limiting sense. For example, the kinds of parameter data may be set as parameter data that relate to electromagnetic properties of the coil 12a. In this case, it is possible to use a voltmeter, an ammeter, or a flux detector to obtain the resulting parameter data (such as inductance and flux density, not illustrated).

Also in the example estimator-learning data set illustrated in FIG. 5, the active parameter data (control parameter) may be upper-level controlled variables such as directly manipulated variables (such as winding speed, winding tension, and deriving angle) associated with the supplied material 11. Alternatively, the active parameter data may be lower-level controlled variables such as physical quantities (such as current, voltage, position, speed, and torque) and information (such as command form and gain) that need to be manipulated so as to implement the above manipulated variables.

The control parameter estimator 9 obtained through the machine learning process is capable of recognizing, in a multi-dimensional vector space of a large number of parameter data, a parameter data region (control parameter command region, not illustrated) in which the production facility 1 is able to produce a defective-free product 12, which has target resulting parameter contents. As the resulting parameter has a greater tolerance margin, the target specification region of the resulting parameter becomes larger. In this case, each active parameter data (control parameter command) has a range defined by an upper limit value and a lower limit value relative to one reference target resulting parameter data. In this case, the control parameter estimator 9 outputs the control parameter command using a median value between the upper limit value and the lower limit value.

For the control parameter estimator 9 to more clearly recognize the target specification region, it is possible to employ, as training data, not only the above-described estimator-learning data sets corresponding to defective-free products but also estimator-learning data sets corresponding to defective products. In the learning phase of the control parameter estimator 9, it is possible to distinguish these estimator-learning data sets by labeling the estimator-learning data sets as defective-free products and defective products. For this purpose, it is possible to provide a determination node, not illustrated, in the output layer of the neural network of the control parameter estimator 9 so that the determination node determines whether a product is a defective-free product or a defective product using binary output. In the learning phase of the control parameter estimator 9, it is possible to cause the determination node to learn by error back propagation using training data labels (defective-free product and defective product). The control parameter estimator 9 designed and caused to learn in the above-described manner is capable of outputting, from the determination node, a determination informing that a defective product 12 would result, in response to input of a combination of passive parameter data that makes production of a defective-free product impossible in the operation phase.

While in the above description supervised learning is used for learning of the control parameter estimator 9, it is also possible to use deep reinforcement learning. In the case of deep reinforcement learning, it is possible to make the control parameter estimator 9 more highly rewarded as the resulting parameter is closer to target resulting parameter data.

It will be understood by those skilled in the art that the algorithm for the control parameter estimator 9 to estimate the control parameter command will not be limited to the algorithm using deep learning illustrated in FIG. 5. It is also possible to employ any of other machine learning algorithms such as those using support vector machine and Bayesian network (not illustrated). Use of other machine learning algorithms is similar to use of deep learning in the basic configuration that the output control parameter command ensures that the resulting parameter has target contents relative to the input parameter data.

### 6: Compression Processing at Compressor of Image Data Recorder

The compressor 21's compression processing of compressing image data will be described in detail below. In this embodiment, a difference image data indicating a difference between standard image data and lot image data is extracted, and then the difference image data is subjected to additional compression such as encoding. Thus, double compression is performed to decrease the data capacity of the lot image data.

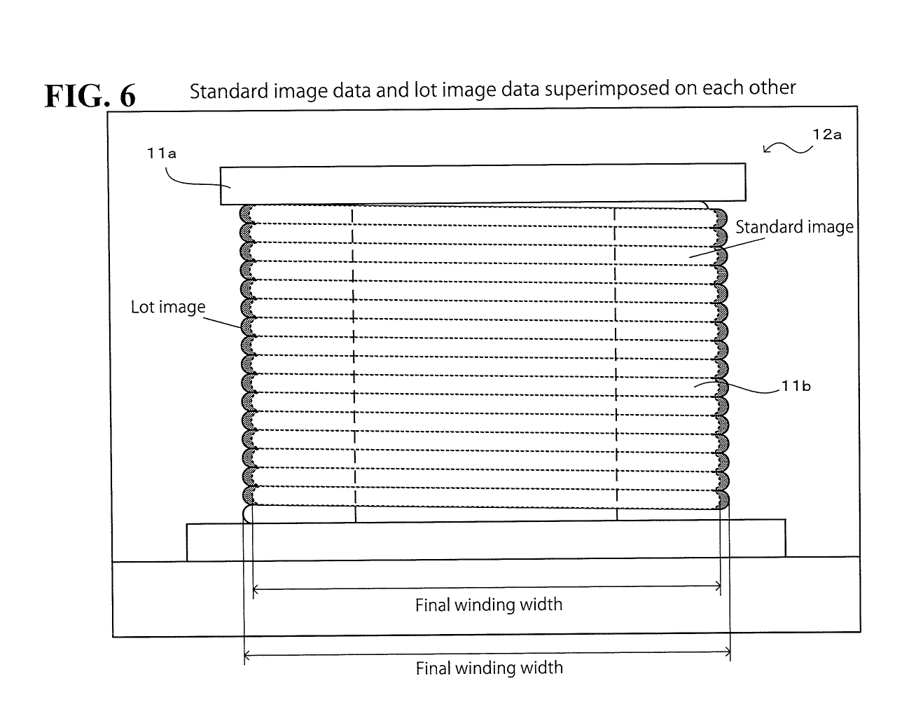

FIG. 6 illustrates an example of standard image data and an example of lot image data superimposed on each other. As used herein, the standard image data refers to image data of an exterior of a product 12 having the target resulting parameter data as the content of the resulting parameter, that is, a product 12 produced according to designed values and having desired specifications and a desired quality. The standard image data is prepared in advance by a user and stored in a storage area of the compressor 21. Also as used herein, the lot image data refers to image data of a lot product 12 picked up by the camera 5 after the lot product 12 is produced by the production facility 1. The standard image data is a non-limiting example of the “first image data” and the “image data of the imaging target in a reference state” recited in the appended claims. The lot image data is a non-limiting example of the second image data recited in the appended claims.

Both the standard image data and the lot image data are obtained by picking up an image of the coil 12a, which is the product 12, from the same imaging direction (from the side illustrated in FIG. 6) and at the same scale. Still, some lot products may have a manufacturing error from designed values at the edges of the wire 11b in its winding width direction illustrated in FIG. 6. When the lot image data of such lot product is superimposed on the standard image data as illustrated in FIG. 6, there is a difference between the standard image data and the lot image data (difference in the winding width, see the shaded portions in FIG. 6). That is, the difference between the standard image data and the lot image data indicates a characteristic of the lot product relative to the standard product. By extracting this difference image data alone as illustrated in FIG. 7, some resulting parameter data of the lot product (mainly resulting parameter data associated with mechanical properties) can be obtained. The function of the compressor 21 to extract the difference image data is a non-limiting example of the extractor recited in the appended claims.

In the difference image data, most of the area is white space (see the white space in FIG. 7), with the only non-white space being the comparatively small different portion. Because of this nature of the difference image data, the difference image data can be subjected to reversible compression processing such as run-length encoding (RLE) and LZ78, resulting in an advantageous decrease in data capacity.

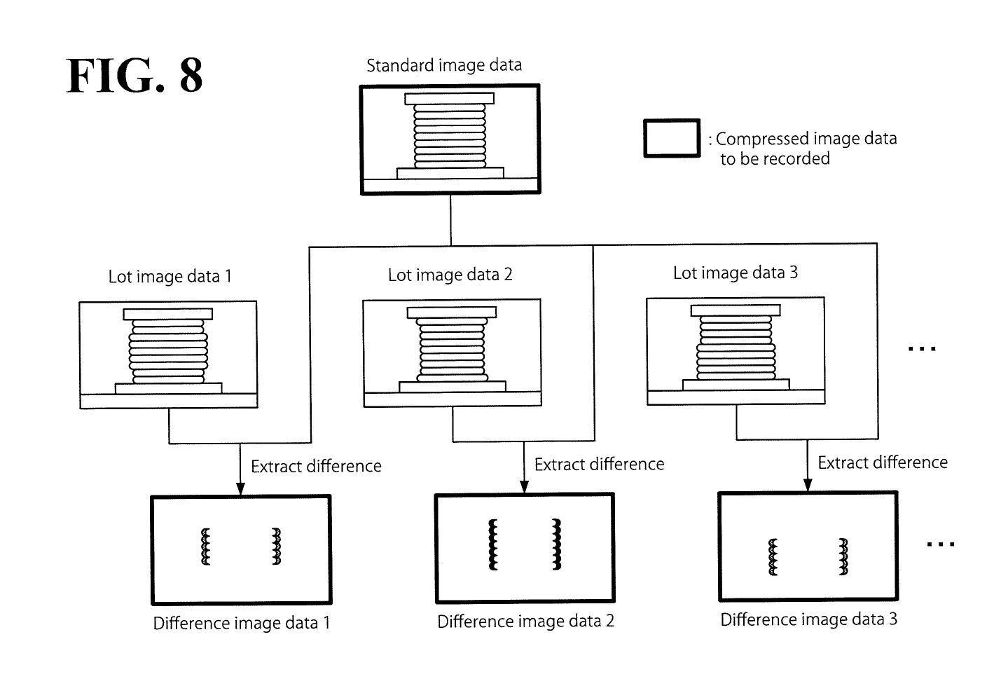

In this embodiment, the production facility 1 produces a large number of lot products and employs double compression, as described above. Specifically, as illustrated in FIG. 8, one standard image data serving as a common reference, and pieces of difference image data each corresponding to a different lot image data are subjected to encoding compression. The compressed image data are recorded in the recorder 22. In extracting the difference image data, it is possible to make the different portion of the lot image data distinguishable using a positive sign indicating that the different portion is of an excessive nature (protruding beyond the standard image data) and using a negative sign indicating that the different portion is of a deficient nature (set inward).

In restoring compressed image data at the restorer 23, it is possible to restore the difference image data alone, if the image recognition function of the product parameter data generator 7 is so limited, or restore both the difference image data and the lot image data.

7: Advantageous Effects of this Embodiment

As has been described hereinbefore, in the product quality management system 100 according to this embodiment, the control parameter estimator 9 estimates an active parameter necessary for controlling the production facility 1 to produce a product 12 having target resulting parameter contents under a given passive parameter condition. The control section 10 controls the production facility 1 based on the estimated active parameter. This enables the production facility 1 to stably produce products 12 having a target resulting parameter, even though it is inevitable that the passive parameter, which cannot be manipulated at the production facility 1, is subject to change. This improves the function to manage product quality, such as improving the yield rate.

Also in this embodiment, the resulting parameter data is obtained in the form of image data. Specifically, a plurality of kinds of particular resulting parameter data are recognizable on the exterior of the product 12 and are collectively obtainable in the form of a single image data. Additionally, the single image data is obtainable in a non-contact manner, making data acquirement more sanitary and more efficient. It will be understood by those skilled in the art that the optical sensor to obtain the image data will not be limited to the camera 5 but may be a laser scanner (not illustrated). In the case of a laser scanner, a large number of points on the surface of the product 12 are scanned, and image data is obtained based on distances between the points.

Also in this embodiment, the product quality management system 100 further includes the material parameter data input interface 4, the facility state sensor 2, the environment sensor 3, and the product parameter data generator 7. Into the material parameter data input interface 4, the passive parameter data A is input. Into the environment sensor 3, the passive parameter data B is input. Into the facility state sensor 2, the passive parameter data C is input. The product parameter data generator 7 obtains resulting parameter data Y, which is associated with a predetermined product 12. The controller 8 functions to obtain active parameter data (control parameter command X) associated with production of the predetermined product 12. In the machine learning process of the control parameter estimator 9, the control parameter estimator 9 learns, as a feature quantity, a correlation of the active parameter data (control parameter command X) relative to the passive parameter data A, B, C and the target resulting parameter data Y′. Then, based on the feature quantity, the control parameter estimator 9 estimates the active parameter (control parameter command X). This enables the control parameter estimator 9 to more accurately learn a correlation between the passive parameters A, B, and C, the active parameter X, and the resulting parameter Y, even though the correlation is so complicated that it is difficult to artificially design the correlation in a mathematical model form. This, in turn, enables the control parameter estimator 9 to more accurately estimate, based on the learned correlation, an active parameter X suitable for the passive parameters A, B, and C and the resulting parameter Y (=Y′).

Also in this embodiment, the passive parameter includes an environment parameter associated with the environment of the production facility 1. Examples of the environment include, but are not limited to, external environment, internal environment, and environment at and around the processing position of the production facility 1. Examples of the environment parameter include, but are not limited to, temperature, humidity, vibration, and the amount of incident light. This enables the control parameter estimator 9 to estimate an active parameter in which processing environment factors that can affect specifications and quality of the product 12 are taken into consideration. It will be understood by those skilled in the art that in the event that the production facility 1 is capable of manipulating the processing environment itself, the environment parameter is included in the active parameter (control parameter).

Also in this embodiment, the passive parameter includes a facility state parameter associated with a passive state (inevitable state that cannot be actively manipulated) of the production facility 1. A non-limiting example of the facility state parameter is how much the production facility 1 is degraded, such as cumulative total operation time and the amount of mechanical wear. This enables the control parameter estimator 9 to estimate an active parameter in which passive state factors of the production facility 1 that can affect specifications and quality of the product 12 are taken into consideration.

Also in this embodiment, the passive parameter includes a material parameter associated with the material 11, which is supplied to the production facility 1. Examples of the material 11 include, but are not limited to, a material of the product 12 and a processing aid material (such as filler material for use in arc welding, catalyst for use in chemical processing, and nourishing solution for use in plant factories). Examples of the material parameter include, but are not limited to, material quality, composition ratio, pre-processing state, plant variety, mechanical properties, chemical properties, and electromagnetic properties. This enables the control parameter estimator 9 to estimate an active parameter in which material-related factors that can affect specifications of the product 12 are taken into consideration. In the event that the material parameter varies comparatively narrowly, it is possible to produce products 12 having the same resulting parameter by adjusting (estimating) the active parameter. In the event that materials 11 supplied to the production facility 1 have the same specifications and quality, it is possible to remove the material parameter from the passive parameter. Contrarily, in the event that materials 11 supplied to the production facility 1 vary in specifications and quality, it is possible to provide a sensor dedicated to obtaining material parameter data. For example, it is possible to use an additional camera to pick up an image of the material 11 and use a material parameter data generator (not illustrated) to recognize the obtained image data, thereby generating material parameter data. In this case, it is possible to detect and manage the material parameter data on a product 12-lot basis, on an individual-material 11 basis, or on a supplied-material-unit basis.

Also in this embodiment, the active parameter includes a control parameter associated with a controlled variable(s) manipulable at the production facility 1. Examples of the controlled variable include, but are not limited to, mechanical controlled variables, electromagnetic controlled variables, and chemical controlled variables. This enables the control parameter estimator 9 to estimate an active parameter as controlled variables that are associated with processing in the production facility 1 and that can affect specifications and quality of the product 12. The active parameter may be upper-level controlled variables such as directly manipulated variables associated with the supplied material 11. Examples of the upper-level controlled variables in the case of mechanical processing include, but are not limited to, applied tension, compressive force, shearing force, heating temperature, heating duration, the amount of light radiation, and radiation wavelength. Alternatively, the active parameter may be lower-level controlled variables such as input physical quantities (such as current, voltage, position, speed, and torque) and settings (such as command form and gain) that need to be manipulated so as to implement the above manipulated variables.

Also in this embodiment, the resulting parameter includes a product parameter associated with a state of the product 12 (state that can be affected by the passive parameter and the active parameter). Examples of the resulting parameter include, but are not limited to, mechanical properties, electromagnetic properties, chemical properties, specifications, functions, and quality. This enables the control parameter estimator 9 to estimate an active parameter that makes the state of the product 12 closer to target specifications and a target quality.

Also in this embodiment, the production facility 1 further includes the compressor 21, the storage, and the restorer 23. The compressor 21 extracts a difference image data indicating a difference between a lot image data and a predetermined standard image data, among a plurality of image data picked up on an individual-product 12 basis. The compressor 21 may further subject the difference image data to encoding compression. The storage stores the standard image data and the difference image data (or encoded data of the standard image data and encoded data of the difference image data). The restorer 23 restores the lot image data (or the standard image data and the difference image data) stored in the storage based on the standard image data and the difference image data (or the encoded data of the standard image data and the encoded data of the difference image data). Generally, image data has a large capacity, but even when image data have been obtained in large volumes, the above configuration advantageously decreases the capacity of image data (lot image data) other than the standard image data. This increases the speed of communication between the compressor 21 and the storage, and decreases the memory capacity of the storage. Also, by restoring the standard image data and the lot image data (or the difference image data) at the restorer 23, the resulting parameter data can be obtained accurately. Also, in the event that the difference image data varies in capacity and/or content to an unexpected degree, this can contribute to detection of an abnormality in the material, the environment, and/or the production facility 1.

Also in this embodiment, the standard image data is an image data of the imaging target in a reference state. This ensures that a difference with the reference state can be detected directly based on the content of the difference image data.

### 8: Modifications

Modifications of the embodiment will be described below.

### 8-1: Modified Configuration of Control Parameter Estimator

In the above-described embodiment, the control parameter estimator 9 is made up of a neural network, and designed to receive three kinds of passive parameter data (material parameter data, environment parameter data, and facility state parameter data) and output one median-value control parameter command, as illustrated in FIG. 4. This configuration, however, is not intended in a limiting sense. The control parameter estimator 9 may be designed and caused to learn in any of other various input-output configurations, depending on the production facility to which the control parameter estimator 9 is applied and/or depending on how the product 12 is produced.

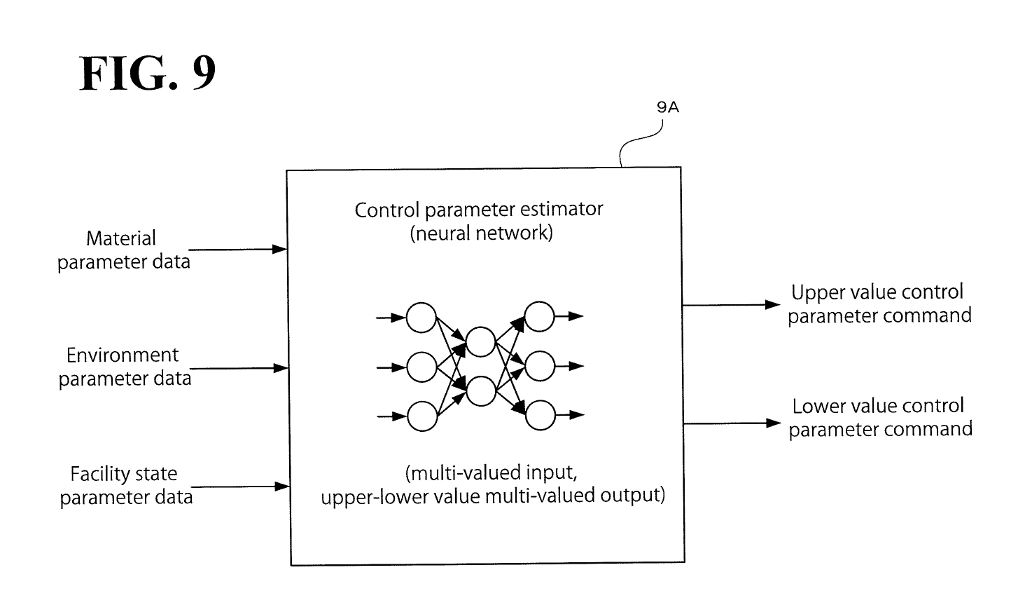

In one modification, a range of target resulting parameter data may be specified. In this case, as illustrated in FIG. 9, a control parameter estimator 9A may be designed and caused to learn. Specifically, the control parameter estimator 9A outputs an upper limit value (upper-limit control parameter command in FIG. 9) and a lower limit value (lower-limit control parameter command in FIG. 9) of a control parameter command necessary for producing a product 12 that is in a state corresponding to the range of target resulting parameter data. This provides the control parameter command with a tolerance for satisfying the range of target resulting parameter data, that is, the control parameter command can be set with a tolerance.

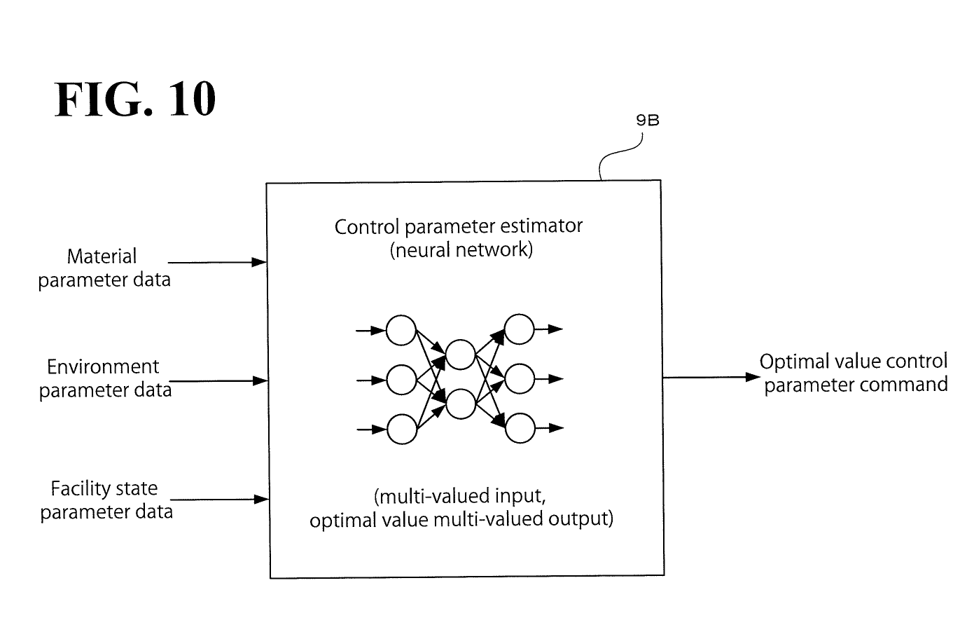

In another modification, the control parameter estimator 9 may estimate an optimal value of the control parameter command to optimize a particular operating condition of the production facility 1. Specifically, when the production facility 1 is caused to operate at a predetermined control parameter command, operation parameters (such as consumption power and production tact time) associated with the operation of the production facility 1 vary depending on the control parameter command. In light of the circumstances, when the control parameter command has a tolerance (upper limit value and lower limit value) for obtaining target resulting parameter data, as described above, a control parameter estimator 9B illustrated in FIG. 10 may be designed to output an optimal value of the control parameter command alone to optimize a particular operation parameter. In this case, it is possible to provide a configuration that detects operation parameter data associated with operation of the production facility 1, and after the supervised learning described in the above embodiment, to cause the control parameter estimator 9 to learn by deep reinforcement learning using a reward that is based on target operation parameter data. This enables the control parameter estimator 9 to estimate a control parameter command suitable for operating conditions such as consumption power reduction and production tact time reduction.

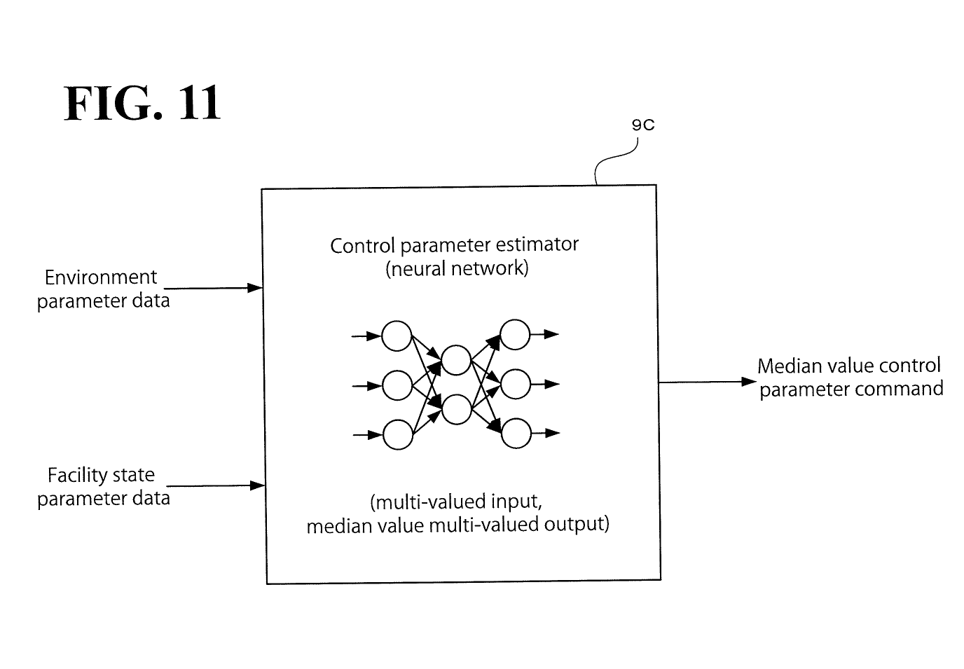

In still another modification, the production facility 1 may be dedicated to mass-production of the same products. Specifically, the production facility 1 may always be supplied materials 11 having the same material parameter data and always produce products 12 having the same target resulting parameter data. In this case, a control parameter estimator 9C illustrated in FIG. 11 may be designed to omit receipt of material parameter data. Also, if the facility state parameter is so small that the facility state parameter varies negligibly narrowly and/or the facility state parameter is negligibly influential to the resulting parameter, the control parameter estimator 9C may be designed to omit receipt of the facility state parameter (this configuration is not illustrated).

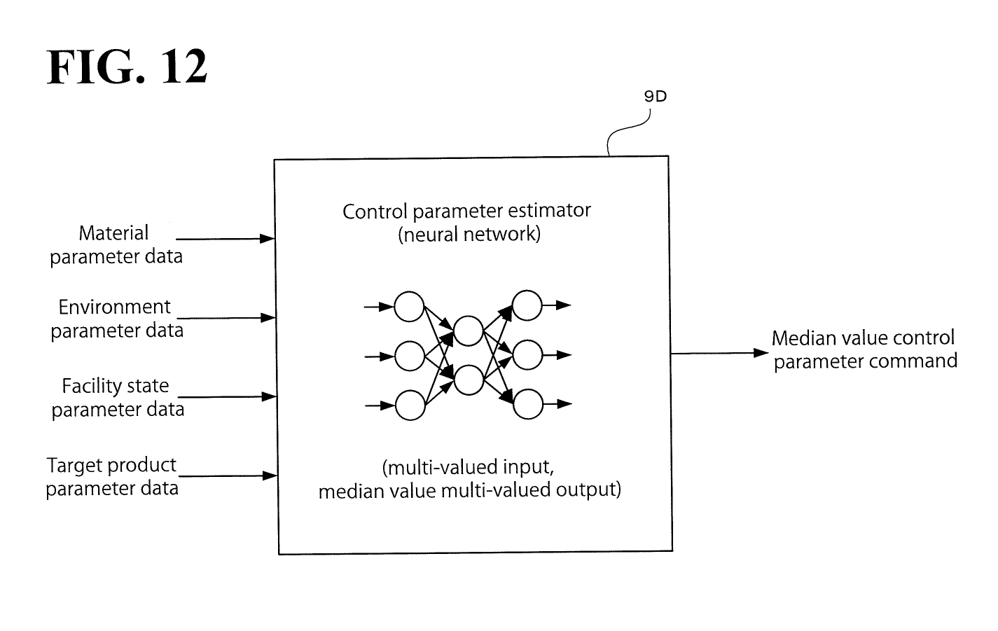

In still another modification, in food product factories and chemical plants, the production facility 1 may be dedicated to production of a wide variety of products 12 from various kinds of materials 11. In this case, a control parameter estimator 9D illustrated in FIG. 12 may be designed to receive three kinds of passive parameter data and one target resulting parameter data and output one control parameter command.

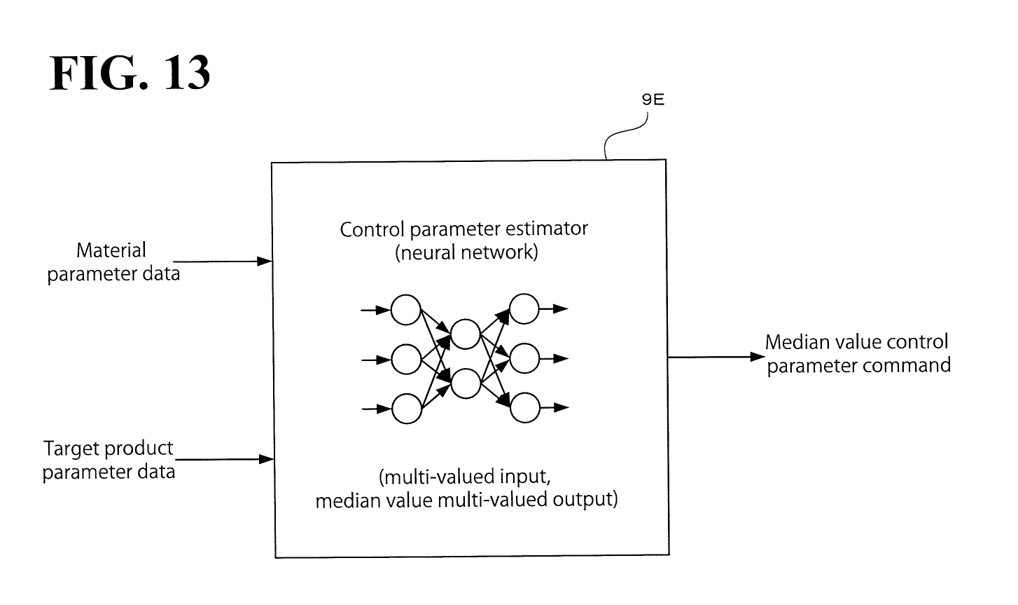

In still another modification, in plant factories, environment parameters (such as temperature and humidity) may be manipulable at the production facility 1, and the production facility 1 may produce plant products of a wide variety of characteristics from a particular variety of seed (material parameter). In this case, a control parameter estimator 9E illustrated in FIG. 13 may be designed to receive material parameter data and target resulting parameter data and output one control parameter command. It is noted that facility state parameter data is not illustrated in FIG. 13.

### 8-2: Difference Image Data Extracted Between Adjacent Lots

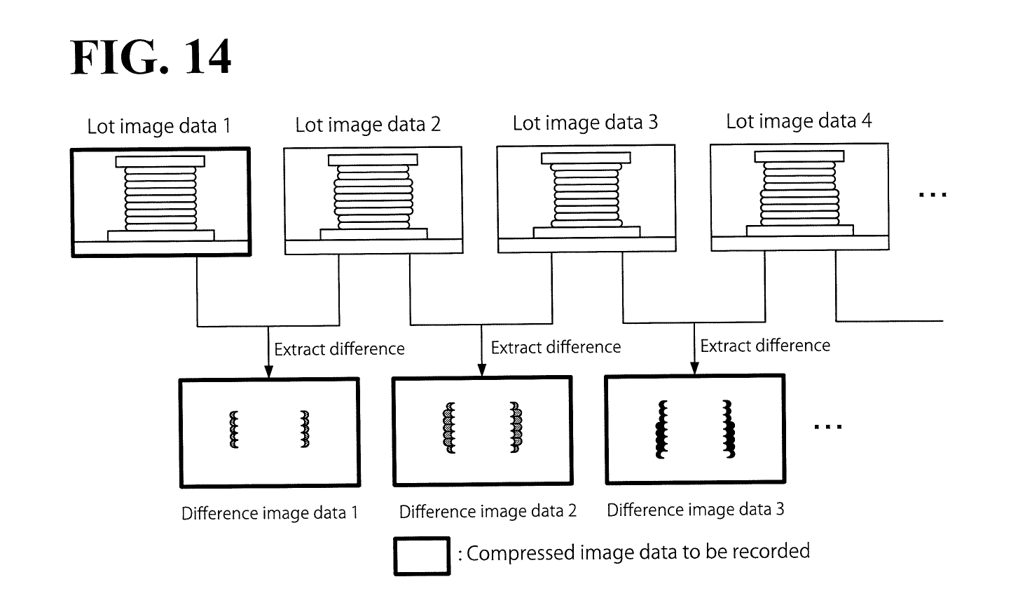

In the image compression processing described in the above embodiment, a difference image data is extracted from between a common standard image data and a lot image data, as illustrated in FIG. 8. This configuration, however, is not intended in a limiting sense. In one modification illustrated in FIG. 14, it is possible to extract a difference image data indicating a difference between a lot image data of an immediately previous product 12 and a lot image data of the next product 12, and to subject the difference image data to encoding compression. In this case, the lot image data of the first lot product 12 and the difference image data of the lot products 12 following the first lot product 12 are subjected to encoding compression and recorded in the recorder 22. In decoding processing, the difference image data of the second lot product 12 is decoded first, followed by decoding of the difference image data of the third lot product 12, the fourth lot product 12, and so forth.

Thus, in this modification, when a difference image data is extracted based on a lot image data of one product 12, the lot image data of the product 12 immediately previous to the one product 12 is used as reference image data such that a difference between the reference image data and the lot image data of the one product 12 is extracted as difference image data. That is, the difference image data obtained in time order may vary over time. This ensures that how an abnormality, if any, changes over time can be observed.

### 8-3: Active Parameter Estimated by Feedback of Resulting Parameter

In the above-described embodiment, an active parameter suitable for the passive parameter and the resulting parameter is estimated. This configuration, however, is not intended in a limiting sense. In one modification, it is possible to obtain resulting parameter data from the product 12 and to use the resulting parameter data as a feedback value to estimate and adjust an active parameter so that the resulting parameter data is closer to target resulting parameter data.

This configuration is different from mechanical or electromagnetic feedback loop control performed in a servo, for example, but is equivalent to upper-level feedback loop control performed by the controller 8 for specifications and quality of the product 12. That is, the production facility 1 may estimate an active parameter (control parameter command) that minimizes the error between the resulting parameter of the previous product 12 and a target resulting parameter input in advance.

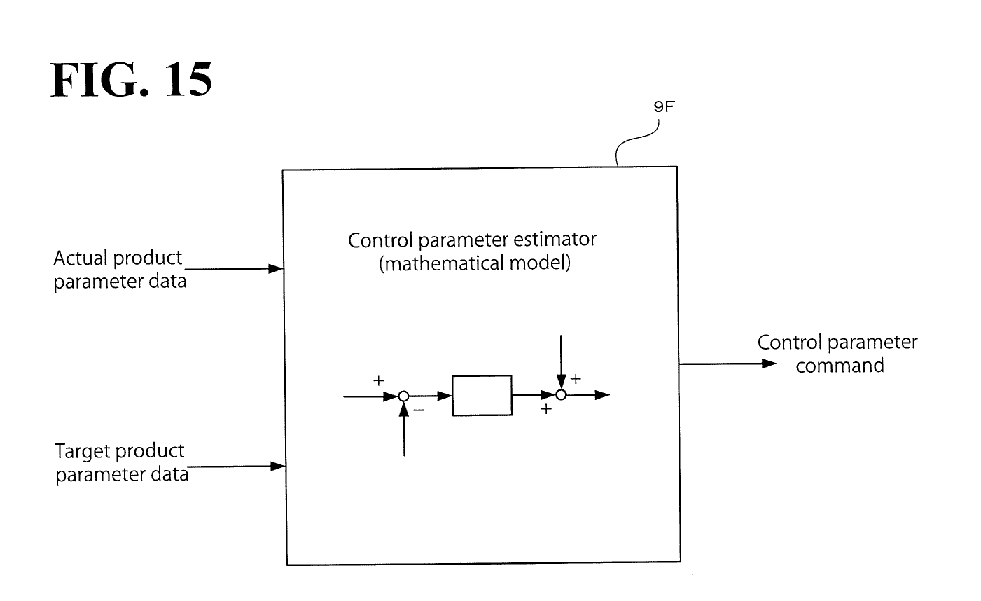

Specifically, as illustrated in FIG. 15, a control parameter estimator 9F may receive actual product parameter data of a product and target product parameter data and output a control parameter command based on a mathematical model (including feedforward and observer) corresponding to a feedback loop. Thus, the control parameter estimator 9 can be implemented using a mathematical model, instead of using machine learning as in the above embodiment. The control parameter estimator 9F may also receive passive parameter data and perform feedforward processing (not illustrated) based on the passive parameter data.

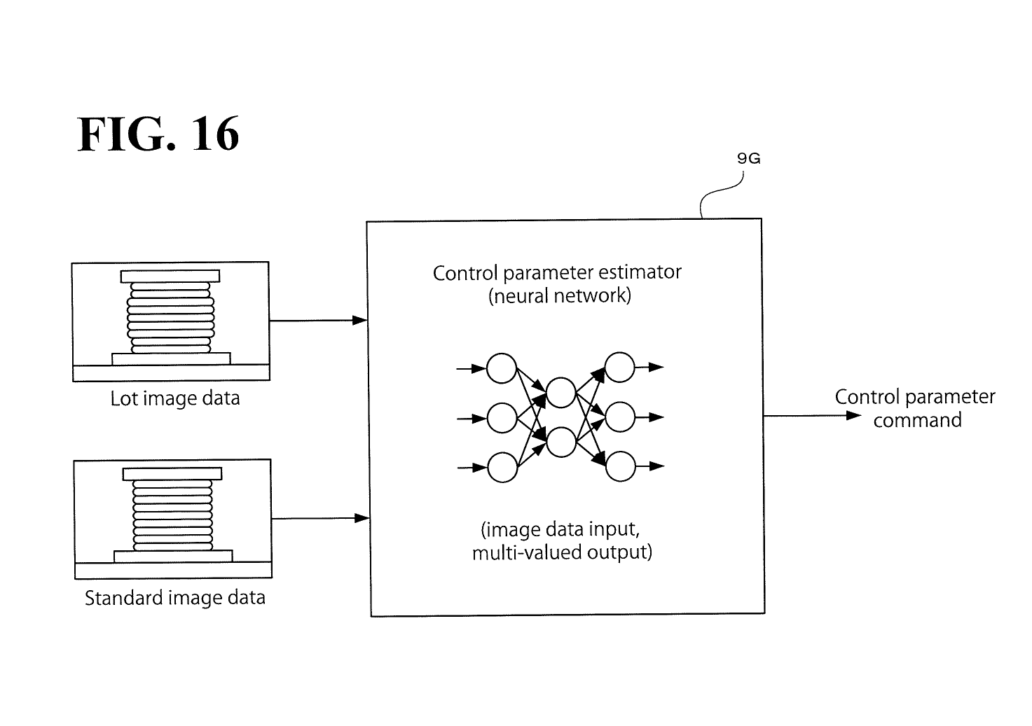

In another modification, illustrated in FIG. 16, a control parameter estimator 9G may receive two kinds of image data: image data of the product 12 as product parameter data; and standard image data as target product parameter data. That is, this configuration is quality management control involving feedback of vision data of the product 12. In this case, the control parameter estimator 9G recognizes the two kinds of image data using, for example, convolutional neural network to detect an error between the two kinds of image data, and estimates a control parameter command that minimizes the error. In this case as well, the control parameter estimator 9G may also receive passive parameter data and output a control parameter command (not illustrated) in which the passive parameter data are taken into consideration.

As used herein, the terms “perpendicular”, “parallel”, and “plane” may not necessarily mean “perpendicular”, “parallel”, and “plane”, respectively, in a strict sense. Specifically, the terms “perpendicular”, “parallel”, and “plane” mean “approximately perpendicular”, “approximately parallel”, and “approximately plane”, respectively, with design-related and production-related tolerance and error taken into consideration.

Also, when the terms “identical”, “same”, “equivalent”, and “different” are used in the context of dimensions, magnitudes, sizes, or positions, these terms may not necessarily mean “identical”, “same”, “equivalent”, and “different”, respectively, in a strict sense. Specifically, the terms “identical”, “same”, “equivalent”, and “different” mean “approximately identical”, “approximately same”, “approximately equivalent”, and “approximately different”, respectively, with design-related and production-related tolerance and error taken into consideration.

Otherwise, the above-described embodiments and modifications may be combined in any manner deemed suitable.

Obviously, numerous modifications and variations of the present disclosure are possible in light of the above teachings. It is therefore to be understood that within the scope of the appended claims, the present disclosure may be practiced otherwise than as specifically described herein.

1. A product quality management system, comprising:
a production facility configured to produce a product having a target resulting parameter;
estimation circuitry configured to estimate an active parameter for controlling the production facility in producing the product under a predetermined passive parameter condition; and
control circuitry configured to control the production facility based on the active parameter estimated by the estimation circuitry.

2. The product quality management system according to claim 1, wherein the estimation circuitry is further configured to obtain a passive data as a passive parameter associated with production of a predetermined product, and obtain a resulting data as a resulting parameter of the predetermined product, and the estimation circuitry is configured to estimate the active parameter based on at least one data among the passive data of the predetermined product and the resulting data of the predetermined product.

3. The product quality management system according to claim 2, wherein the estimation circuitry is configured to obtain the resulting data in a form of image data.

4. The product quality management system according to claim 2, wherein the processing circuitry is further configured to obtain an active data as the active parameter of the predetermined product, and the estimation circuitry is further configured to perform machine learning to obtain a correlation between the active data and at least one data among the passive data and the resulting data, and estimate the active parameter based on the correlation.

5. The product quality management system according to claim 2, wherein when the resulting parameter is specified in a form of a target range, the estimation circuitry is further configured to estimate a range of the active parameter keeping the resulting parameter of the predetermined product within the target range.

6. The product quality management system according to claim 2, wherein the estimation circuitry is configured to estimate an optimal value of the active parameter to optimize an operating condition of the production facility.

7. The product quality management system according to claim 1, wherein the passive parameter includes an environment parameter associated with an environment of the production facility.

8. The product quality management system according to claim 1, wherein the passive parameter includes a facility state parameter associated with a passive state of the production facility.

9. The product quality management system according to claim 1, wherein the passive parameter includes a material parameter associated with a material supplied to the production facility.

10. The product quality management system according to claim 1, wherein the active parameter includes a facility control parameter associated with a controlled variable manipulable at the production facility.

11. The product quality management system according to claim 1, wherein the resulting parameter includes a product parameter associated with a state of the product.

12. The product quality management system according to claim 3, wherein the image data includes a plurality of image data each obtained by picking up an image of an imaging target, the imaging target including at least one of a material and the product, the plurality of image data including a first image data and a second image data different from the first image data, and the estimation circuitry is further configured to extract a difference image data indicating a difference between the first image data and the second image data, store the first image data and the difference image data in a storage, and restore the second image data based on the first image data and the difference image data stored in the storage.

13. The product quality management system according to claim 12, wherein the first image data includes an image data of the imaging target in a reference state.

14. The product quality management system according to claim 12, wherein the first image data includes an image data of a previous imaging target supplied or produced immediately before the imaging target of the second image data is supplied or produced.

15. A method for managing quality of a product using a production facility, comprising:
estimating an active parameter for controlling a production facility configured to produce a product having a target resulting parameter in producing the product under a predetermined passive parameter condition; and
controlling the production facility based on the active parameter estimated.

16. The product quality management system according to claim 3, wherein the processing circuitry is further configured to obtain an active data as the active parameter of the predetermined product, the estimation circuitry is further configured to perform machine learning to obtain a correlation between the active data and at least one data among the passive data and the resulting data, and estimate the active parameter based on the correlation.

17. The product quality management system according to claim 3, wherein when the resulting parameter is specified in a form of a target range, the estimation circuitry is further configured to estimate a range of the active parameter keeping the resulting parameter of the predetermined product within the target range.

18. The product quality management system according to claim 4, wherein when the resulting parameter is specified in a form of a target range, the estimation circuitry is further configured to estimate a range of the active parameter keeping the resulting parameter of the predetermined product within the target range.

19. The product quality management system according to claim 16, wherein when the resulting parameter is specified in a form of a target range, the estimation circuitry is further configured to estimate a range of the active parameter keeping the resulting parameter of the predetermined product within the target range.

20. The product quality management system according to claim 3, wherein the estimation circuitry is further configured to estimate an optimal value of the active parameter to optimize an operating condition of the production facility.
